(19) United States
(12) Patent Application Publication
(10) Pub. No.: US 2025/0119010 A1
(43) Pub. Date: Apr. 10, 2025

(54) ROTOR

(71) Applicants: TOYOTA BOSHOKU KABUSHIKI KAISHA, Aichi-ken (JP); TOYOTA JIDOSHA KABUSHIKI KAISHA, Aichi-ken (JP)

(72) Inventors: Daisuke HOMMA, Anjo-shi (JP); Hiroshi AIHARA, Toyota-shi (JP); Hiroki MORITA, Nagoya-shi (JP)

(73) Assignees: TOYOTA BOSHOKU KABUSHIKI KAISHA, Aichi-ken (JP); TOYOTA JIDOSHA KABUSHIKI KAISHA, Aichi-ken (JP)

(21) Appl. No.: 18/901,170

(22) Filed: Sep. 30, 2024

(30) Foreign Application Priority Data
Oct. 6, 2023 (JP) 2023-174600

(51) Int. Cl. H02K 1/276

(52) U.S. Cl. CPC H02K 1/276

(57) ABSTRACT

A rotor includes a rotor core that includes a magnet housing hole, multiple magnet members that are accommodated in the magnet housing hole in a state of being separated from each other in a planar direction orthogonal to the stacking direction, and multiple fixing members that respectively fill spaces between an inner surface of the magnet housing hole and outer surfaces of the multiple magnet members. The fixing members press the magnet members against the inner surface of the magnet housing hole by foaming of a foaming agent, thereby fixing the magnet members. The magnet housing hole includes multiple recesses that are respectively filled with the fixing members.

### CROSS-REFERENCE TO RELATED APPLICATIONS

This application is based upon and claims the benefit of priority from prior Japanese Patent Application No. 2023-174600, filed on Oct. 6, 2023, the entire contents of which are incorporated herein by reference.

### BACKGROUND

### 1. Field

The present disclosure relates to a rotor.

### 2. Description of Related Art

Japanese Laid-Open Patent Publication No. 2020-115712 discloses a rotor that includes a rotor core, pairs of magnet segments, and insulating sheets. The rotor core has magnet insertion slots extending therethrough in the axial direction. The magnet segments in each pair are accommodated in one of the magnet insertion slots in a state of being arranged in a direction orthogonal to the axial direction of the rotor core. The two magnets are wrapped with an insulating sheet.

Each insulating sheet includes a sheet layer and bonding layers provided on the opposite surfaces of the sheet layer. Each bonding layer has a foaming property that allows it to expand when heated. By foaming within a magnet insertion slot, the bonding layers fix the corresponding pair of magnet segments to the rotor core.

When two magnet segments are accommodated in each magnet insertion slot, the magnet segments may come into contact with each other and short-circuit. This increases the eddy currents generated in the magnet segments. The insulating sheet described in the publication is wound in a B-shaped configuration around the pair of magnet segments, with both ends positioned on the dividing surfaces of the magnet segments. This arrangement prevents the magnet segments from short-circuiting.

When an insulating member, such as the insulating sheet described in the publication, is wound around multiple magnet segments, the amount of the material for the insulating member may increase. Therefore, in manufacturing rotors, it is desirable to suppress the increase in the amount of the material for insulating members.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a rotor includes a rotor core, multiple magnet members, and multiple fixing members. The rotor core includes multiple stacked iron core pieces. Each of the iron core pieces includes a through-hole. The rotor core includes a magnet housing hole formed by the through-holes of the multiple iron core pieces connected together in a stacking direction of the multiple iron core pieces. The magnet members are accommodated in the magnet housing hole in a state of being separated from each other in a planar direction orthogonal to the stacking direction. The fixing members respectively fill spaces between an inner surface of the magnet housing hole and outer surfaces of the magnet members. The fixing members press the magnet members against the inner surface of the magnet housing hole by foaming of a foaming agent, thereby fixing the magnet members. The magnet housing hole includes multiple recesses that are formed by notches formed in peripheral edges of the through-holes of the multiple iron core pieces and are respectively filled with the fixing members.

Other features and aspects will be apparent from the following detailed description, the drawings, and the claims.

### BRIEF DESCRIPTION OF THE DRAWINGS

FIG. 1 is a perspective view showing a rotor according to an embodiment.

FIG. 2 is a cross-sectional view of a magnet housing hole of the rotor shown in FIG. 1.

FIG. 3 is a cross-sectional view taken along line 3-3 of FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

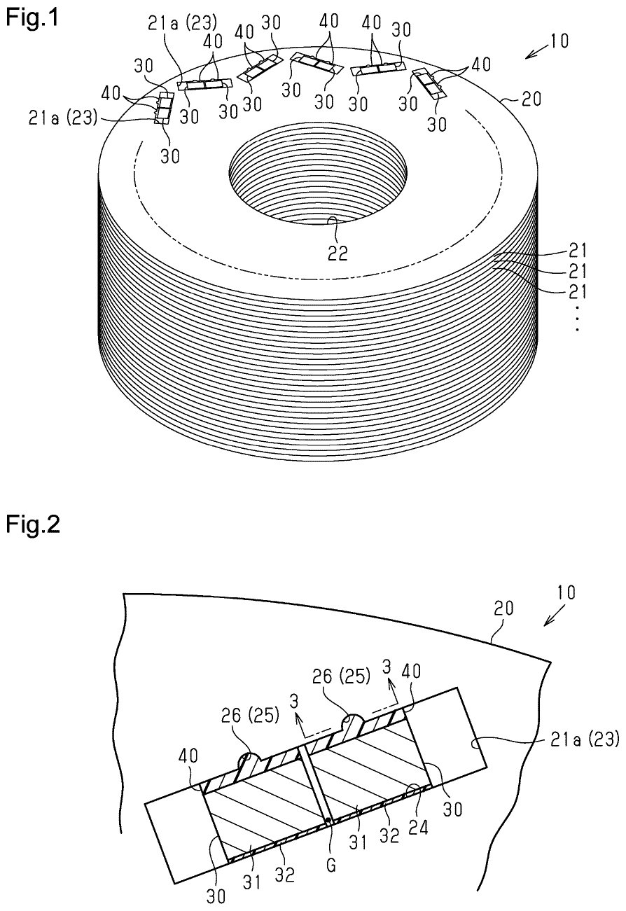

A rotor 10 according to an embodiment will now be described with reference to FIGS. 1 to 3.

### Rotor 10

As shown in FIG. 1, the rotor 10 includes a rotor core 20, multiple magnet members 30, and multiple fixing members 40. The rotor 10 is, for example, a rotor used for a magnet-embedded motor.

### Rotor Core 20

The rotor core 20 is substantially cylindrical. The rotor core 20 is formed by stacking multiple iron core pieces 21 punched from a magnetic steel sheet.

In the following description, the direction in which the iron core pieces 21 are stacked will simply be referred to as a stacking direction. The radial direction of the rotor core 20 will simply be referred to as a radial direction. The circumferential direction of the rotor core 20 will simply be referred to as a circumferential direction.

The rotor core 20 includes a center hole 22 and magnet housing holes 23. A shaft (not shown) is inserted into the center hole 22. The magnet members 30 are accommodated in the magnet housing holes 23. The center hole 22 and the magnet housing holes 23 extend through the rotor core 20 in the stacking direction. The magnet housing holes 23 are formed at a distance from each other in the circumferential direction. Any two of the magnet housing holes 23 that are adjacent to each other in the circumferential direction are inclined in opposite directions with respect to the circumferential direction.

The iron core pieces 21 respectively include through-holes 21a, which form the magnet housing hole 23. Each magnet housing hole 23 is formed by the through-holes 21a of the iron core pieces 21 being connected together in the stacking direction.

As shown in FIG. 2, each magnet housing hole 23 includes a housing portion 24, in which the magnet members 30 are accommodated, and recesses 25, which are recessed from a peripheral edge of the housing portion 24 in a radially outward direction of the housing portion 24. The magnet housing hole 23 includes, for example, two recesses 25 formed at a distance from each other on an inner surface on the outer side in the radial direction of the housing portion 24.

The cross-sectional shape of the housing portion 24 orthogonal to the stacking direction is a substantially rectangular shape having long sides and short sides. The cross-sectional shape of the housing portion 24 is constant over the entire length in the stacking direction.

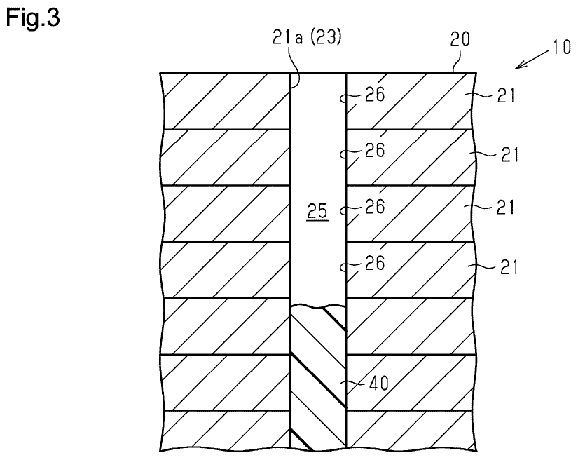

As shown in FIG. 3, each recess 25 is formed by notches 26 formed in peripheral edges of the through-holes 21a of the iron core pieces 21. Specifically, the recess 25 is formed by the notches 26 being connected together in the stacking direction.

As shown in FIG. 2, the cross-sectional shape of each notch 26 orthogonal to the stacking direction is, for example, a semicircular shape. The notches 26 forming each recess 25 have the same shape and size.

### Magnet Members 30

Two of the magnet members 30 are accommodated in each of the magnet housing holes 23. The two magnet members 30 are accommodated in the magnet housing hole 23 in a state of being separated from each other in a planar direction orthogonal to the stacking direction. The two magnet members 30 are accommodated in a state of being separated from each other in the longitudinal direction of the magnet housing hole 23. A gap G is formed between the two magnet members 30. The gap G is formed across the entire space between the two magnet members 30.

Each magnet member 30 includes a magnet body 31 and an insulating member 32 covering an outer surface of the magnet body 31. The magnet body 31 is a magnet that is, for example, a permanent magnet. The insulating member 32 is, for example, an insulating coating applied to an outer surface of the magnet body 31.

The magnet body 31 has an elongated columnar shape extending in the stacking direction. The cross-sectional shape of the magnet body 31 orthogonal to the stacking direction is a substantially rectangular shape having long sides and short sides. The cross-sectional shape of the magnet body 31 is constant over the entire length in the stacking direction. The long-side direction and the short-side direction of the magnet body 31 respectively agree with the long-side direction and the short-side direction of the magnet housing hole 23.

Out of the pair of outer surfaces that form the long sides of the magnet body 31, the insulating member 32 is provided only on and covers the entirety of the outer surface that is located on the inner side in the radial direction. The above-described gap G is formed by outer surfaces of the two magnet bodies 31 that face each other.

The magnet members 30 are in contact with the inner surface of the magnet housing hole 23 only at the insulating members 32. A gap is provided between an inner surface of the magnet housing hole 23 and an outer surface of each magnet body 31 on a side opposite to the short side forming the gap G. Therefore, only two magnet members 30 and two fixing members 40, which will be discussed below, are disposed in each magnet housing hole 23.

### Fixing Members 40

Each magnet housing hole 23 accommodates two fixing members 40, which correspond to the two magnet members 30, respectively. Each fixing member 40 is disposed between an inner surface of the magnet housing hole 23 in which the recesses 25 are formed and an outer surface of the corresponding magnet member 30 on the outer side in the radial direction.

Although not illustrated, each fixing member 40 includes a foam layer and a bonding layer. The foam layer contains a foaming agent that foams when heated, a resin material, and a curing agent. The bonding layer includes an adhesive. The bonding layer is provided on a surface of the foam layer on one side in the thickness direction. The bonding layer is bonded to an outer surface of the corresponding magnet body 31 on the outer side in the radial direction.

During the manufacturing of the rotor 10, two magnet members 30, to which the non-foamed fixing members 40 are bonded, are accommodated in each magnet housing hole 23 while being spaced apart from each other. At this time, a gap exists between each fixing member 40 and an inner surface of the magnet housing hole 23. Thereafter, the rotor core 20 is heated so that the foam layers foam in the magnet housing holes 23. Since the thickness of each fixing member 40 increases due to the foaming, the gap between the fixing member 40 and the inner surface of the magnet housing hole 23 is eliminated. In other words, the fixing member 40 fills the space between the inner surface of the magnet housing hole 23 and an outer surface of the corresponding magnet 30. As a result, the magnet 30 is pressed against the inner surface of the magnet housing hole 23, so that the magnet 30 is fixed to the rotor core 20. The use of the fixing members 40 eliminates the need to fill the magnet housing holes 23 with resin to secure the magnet members 30 to the rotor core 20.

Each fixing member 40 fills a part of the housing portion 24 and the entirety of the corresponding recess 25 by foaming of the foam layer. The fixing member 40 is positioned by filling the recess 25 with the fixing member 40. As a result, each magnet 30 is positioned with respect to the magnet housing hole 23. For illustrative purposes, the fixing member 40, which fills the recess 25, is partly omitted in FIG. 3.

In order to position the fixing member 40 effectively, it is preferable that the radius of curvature of each recess 25, that is, the radius of curvature of the notches 26 be, for example, in a range of 0.2 mm to 0.5 mm. If the radius of curvature of the notches 26 is less than 0.2 mm or greater than 0.5 mm, the fixing member 40 is less likely to fill the recess 25 during the foaming of the fixing member 40. As a result, gaps may form between the fixing member 40 and the recess 25, potentially leading to insufficient positioning of the magnet 30 by the fixing member 40.

The present embodiment has the following advantages.

(1) The rotor 10 includes the multiple magnet members 30 and the multiple fixing members 40. The magnet members 30 accommodated in each magnet housing hole 23 are spaced apart from each other in a planar direction orthogonal to the stacking direction. Each magnet housing hole 23 includes recesses 25, which are formed by notches 26 formed in peripheral edges of the through-holes 21a of the iron core pieces 21. The recesses 25 are respectively filled with fixing members 40.

According to the above-described configuration, the recesses 25 are filled with the fixing members 40, provided in correspondence with the magnet members 30, which are spaced apart from each other. As a result, the magnet members 30 are positioned inside each magnet housing hole 23, so that the magnet members 30 are prevented from approaching each other. Therefore, it is not necessary to interpose the insulating member 32 between the magnet members 30 in order to prevent the magnet members 30 from short-circuiting. This prevents the amount of the material for the insulating member 32 from increasing.

(2) The fixing members 40 are provided on the outer surfaces of the magnet members 30 on the radially outer side of the rotor core 20.

When the rotor 10 rotates, the outer surfaces of the magnet members 30 on the radially outer side are pressed against the inner surface of the magnet housing hole 23 by a centrifugal force acting on the magnet members 30. This may break or chip the magnet members 30.

In this regard, according to the above-described configuration, the fixing members 40 are provided on the outer surfaces of the magnet members 30 on the radially outer side of the rotor core 20. This helps to mitigate the aforementioned issues.

(3) The insulating members 32 are provided only on the outer surfaces of the magnet bodies 31 on the side opposite to the fixing members 40. The magnet members 30 are in contact with the inner surface of the magnet housing hole 23 only at the insulating members 32.

When the magnet body 31 comes into contact with the inner surface of the magnet housing hole 23, the magnet body 31 and the rotor core 20 short-circuit, so that eddy currents generated in the magnet body 31 during use of the rotor 10 increase. Therefore, an insulating member 32 is preferably provided between the magnet body 31 and the inner surface of the magnet housing hole 23.

According to the above-described configuration, in order to avoid contact between the magnet body 31 and the rotor core 20, the insulating member 32 is provided only on the outer surface of the magnet body 31 on the side opposite to the fixing member 40. Therefore, it is not necessary to provide the insulating member 32 over the entire circumference of the outer surface of the magnet body 31. This prevents the amount of the material for the insulating member 32 from increasing.

### Modifications

The above-described embodiment may be modified as follows. The above-described embodiment and the following modifications can be combined as long as the combined modifications remain technically consistent with each other.

The rotor 10 may include three or more magnet members 30 accommodated in each magnet housing hole 23 in a state of being separated from each other, and three or more fixing members 40 and three or more recesses 25, in accordance with to the magnet members 30.

The insulating members 32 may be insulating sheets bonded to the outer surfaces of the respective magnet bodies 31.

Each insulating member 32 may be provided over the entire circumference of the corresponding magnet body 31, or may be provided on a portion of the outer surface of the magnet body 31 other than the portion on which the fixing member 40 is provided.

Each fixing member 40 may include a curing layer containing a curing agent on a surface of the foam layer opposite to the surface on which the bonding layer is provided.

The fixing member 40 may be provided on each of the outer surfaces of the magnet 30 on the opposite sides in the radial direction. In this case, the recesses 25 are preferably formed at positions corresponding to the respective fixing members 40 in the housing portion 24. In this configuration, the magnet members 30 are in contact with the inner surface of the magnet housing hole 23 only at the fixing members 40. The magnet members 30 thus do not need to be provided with the insulating members 32.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rotor, comprising:
a rotor core that includes multiple stacked iron core pieces, each of the iron core pieces including a through-hole, the rotor core including a magnet housing hole formed by the through-holes of the multiple iron core pieces connected together in a stacking direction of the multiple iron core pieces;
multiple magnet members that are accommodated in the magnet housing hole in a state of being separated from each other in a planar direction orthogonal to the stacking direction; and
multiple fixing members that respectively fill spaces between an inner surface of the magnet housing hole and outer surfaces of the multiple magnet members, the fixing members pressing the magnet members against the inner surface of the magnet housing hole by foaming of a foaming agent, thereby fixing the magnet members,
wherein the magnet housing hole includes multiple recesses that are formed by notches formed in peripheral edges of the through-holes of the multiple iron core pieces and are respectively filled with the fixing members.

2. The rotor according to claim 1, wherein the fixing members are provided on outer surfaces of the magnet members on a radially outer side of the rotor core.

3. The rotor according to claim 1, wherein
the magnet members each include a magnet body and an insulating member that covers an outer surface of the magnet body,
the insulating members are provided only on outer surfaces of the magnet bodies on a side opposite to the fixing members, and
the magnet members are in contact with the inner surface of the magnet housing hole only at the insulating members.
